(19) United States
(12) Patent Application Publication
(10) Pub. No.: US 2026/0018811 A1
(43) Pub. Date: Jan. 15, 2026

(54) TERMINAL BLOCK MADE UP OF A NUMBER OF SERIES TERMINALS WITH A PLURALITY OF CONNECTION DEVICES AND CONNECTION DEVICE

(71) Applicant: Weidmüller Interface GmbH & Co. KG, Detmold (DE)

(72) Inventors: Matthias BÖNSCH, Bielefeld (DE); Torsten JUNG, Horn-Bad Meinberg (DE); Torsten DIEKMANN, Leopoldshöhe (DE)

(21) Appl. No.: 19/335,511

(22) Filed: Sep. 22, 2025

(30) Foreign Application Priority Data
Sep. 23, 2023 (DE) 102024127449.2

(51) Int. Cl. H01R 9/24

(52) U.S. Cl. CPC H01R 9/2408

(57) ABSTRACT

A terminal block includes a plurality of series terminals which can be series-mounted, which are clampingly and/or latchingly connected, and which each have a housing and a plurality of two or more connection devices inserted into the respective housing. The connection devices are designed as direct-plug pressure spring terminals for connecting a respective conductor end. The connection devices each have a busbar, which has at least a respective contact zone for contacting the respective electrical conductor end, and the clamping spring is configured as a pressure spring. Per connection device there is one actuating device which can pivot in the housing about an axis of rotation, wherein the actuating devices are configured like a one- armed lever having an actuating section and a leading contour to act on the clamping limb when the clamping spring is tensioned.

### BACKGROUND

The present invention relates to a terminal block made up of a number of series terminals which each have a plurality of connection devices employing direct-plug pressure spring technology, and a connection device.

Diverse embodiments of direct-plug pressure spring connections (also called "push-In terminals" or "snap-in terminals") are known. They differ principally due to their application, for example depending on the required current-carrying capacity of the busbar, the spring force of the clamping spring and/or their installation conditions, including their installation size. Simple mounting and inexpensive manufacture are long-standing requirements for such a terminal.

Prior art references WO 2014/173 717 Al and EP 1353407 B1 each disclose generic direct-plug pressure spring terminals.

There is a need, however, for a terminal block made up of compact and stable series terminals with direct-plug pressure spring connections that are well-suited for connection of conductors with a relatively large cross-section. There is also a need for a connection device which is well-suited for such a terminal block and can also be employed as a connection for the connection of a conductor end in a plug-and-socket connector or with an apparatus such as a series terminal.

### SUMMARY OF THE DISCLOSURE

Accordingly, it is an object of the present disclosure to provide a terminal block including a plurality of series terminals which can be series-mounted and clampingly and/or latchingly connected. Each series terminal has a housing and a plurality of two or more connection devices inserted into the respective housing, which are designed as direct-plug pressure spring terminals for connecting ends of a respective conductor. The connection devices have at least one busbar having at least one contact zone for contacting the respective electrical conductor, and the clamping spring is configured as a pressure spring with which a conductor end introduced into the connection device can be pressed against the contact zone in order to contact the conductor. Per each connection device there is one actuating device which can pivot in the housing about an axis of rotation and with which a clamping limb of the clamping springs can be moved out of a relaxed position into a tensioned detent position at a retaining and detent spring. The actuating devices are configured like a one-armed lever, which has an actuating section and a leading contour to act on the clamping limb when the clamping spring is tensioned.

It is also an object to provide a connection device for connecting a conductor end and connecting the conductor end to a busbar for one of a terminal block, as described above, for a plug-and-socket connector, or for another electrical apparatus. The device includes a housing and a direct-plug pressure spring terminal inserted into the housing for connecting a respective conductor end. The clamp has at least one busbar, which has a contact zone for contacting the respective electrical conductor, and the clamping spring is configured as a pressure spring with which a conductor end introduced into the connection device can be pressed against the contact zone in order to contact the conductor. One actuating device can pivot in the housing about an axis of rotation to move a clamping limb of the clamping spring out of a relaxed position into a tensioned detent position at a retaining and detent spring. The actuating device is further configured like a one-armed lever, which has an actuating section and a leading contour which acts on the clamping limb when the clamping spring is tensioned.

This gives rise to a stable structure and an ergonomic and simply actuation using a small amount of force. In particular, there also arises a compact structural shape with a small number of parts with simple geometry, such that the terminal block and its actuating devices can be produced inexpensively and are simple to mount.

According to one embodiment, the spacing between an actuating end of the actuating section and a fixed axis of rotation is larger than the spacing between the axis of rotation and the leading contour. This once again significantly optimizes the ergonomic and force-saving actuation and the compact structural shape.

In a further embodiment, the actuating element has a pivot bearing formed by at least one circumferentially closed or circumferentially nonclosed annular track in the housing and by at least one respective circumferentially closed or circumferentially nonclosed annular projection, which is on the actuating section extending perpendicular to the actuating section. The pivot bearing engages in the respective annular track and can be pivoted in this around the axis of rotation through a pivoting angle. In opposite sides of adjacent housings or of the housing and a partition or end plate, there can also be provided in each case one of the circumferentially closed or circumferentially nonclosed circular grooves and a respective circumferentially closed or circumferentially nonclosed annular projection engaging therein. In this way, a very good bearing of the actuating element is created in each case, which allows the required actuation forces to be safely transmitted into the respective connection device.

In another embodiment, the annular projection surrounds the curve of the clamping spring and has a recess on which a leading contour is formed in the circumferential direction, which can be applied against the clamping limb when the actuating element is pivoted in order to move it away from the contact zone and to lock the clamping spring on the retaining and detent spring. These can further improve the actuation and the compact structural form.

In yet a further embodiment, the series terminals can be series-mounted on a mounting rail and are designed such that they can be actuated from a Z-direction perpendicular to the mounting rail. The two conductor ends can be introduced from opposite +Y and -Y directions perpendicular to the Z direction from which they can be actuated into the connection devices. In this way, the terminal block is advantageously configured for a generally 90° actuation, in which the conductor ends can typically be introduced into the connection devices parallel to a control cabinet rear wall. This connecting and releasing of the conductors is particularly easy and practical for a user to carry out.

Preferably, the busbar is also configured to support a respective clamping spring.

In a further embodiment still, the busbar connects, in a commonly conductive manner, a number of the connection devices situated on a common connection plane perpendicular to the series-mounting direction. This leads to a very good power conduction as free from loss as possible, and to a simple structure. These characteristics are optimized and improved in that it can be optional to have the single common, in particular one-piece and/or one-part, busbar provided respectively for all connection devices of respectively two or more adjacent connection planes, so that they are connected commonly in a conductive manner via this one busbar. This enables a good distribution of a common potential to the various connection devices of the respective connection plane or from two neighboring connection planes in each case.

Particularly advantageous is the one-piece configuration of the busbar for preferably all connection devices as a single punched/bent part made of sheet metal which conducts electricity well. This leads to a stable structure with good spring support and excellent conductive connection between the various connection devices. However, multi-piece configurations can also be advantageously used.

Since it is structurally simple, compact and nevertheless functionally safe, it is preferred for the respective clamping springs and the respective retaining and detent springs to be formed in one piece. The clamping spring can be locked with the detent spring in an open position in which a respective conductor end can be introduced into a contact area of the respective connection device. The retaining and detent spring can be released from the locked state with the conductor end when the conductor end is introduced, in order to press the conductor end against the respective contact zone.

It is particularly advantageous for the housings of respectively adjacent series terminals of the terminal block to be mechanically connected to one another at least partially in a force- fitting and/or form-fitting manner in the series-mounting direction. Preferably by corresponding clamping and/or detent means of the respective adjacent housings, such that a terminal block is easily created as a manageable unit.

According to yet another embodiment, in each case two of the housings, which per connection plane are joined together from two or more connection devices into a double-series or multi-series terminal, have one common busbar for the connection devices of both or of the number of connection planes.

However, according to another preferred embodiment, there is a housing on both sides of a center wall, wherein each has a connection plane of two or more connection devices such that it forms a double series terminal with two of the connection planes. A dividing wall in each case is applied to the housing to connect two housings in the series-mounted direction to be series mounted via the dividing wall in a force-fitting or form-fitting manner.

### BRIEF DESCRIPTION OF THE DRAWINGS

The invention is described in greater detail hereinafter with reference to the drawings by means of exemplary embodiments, with further advantages of the invention becoming clear. In the drawings:

FIG. 1 is a perspective view of a first embodiment of a plurality of series terminals, together with an end plate, being joinable together to form a first terminal block;

FIG. 2a is a perspective view of two series terminals with an end plate configured like the terminals and end plate of FIG. 1, which are joinable together to form a double series terminal and a terminal block;

FIG. 2b is a sectional view of a terminal block made up of a number of arrangements of the type from FIG. 2a;

FIG. 3 is an exploded view of the arrangement from FIGS. 2a and 2b;

FIG. 4a is a lateral view of a series terminal of the type from FIGS. a, 2a and 2b with a busbar;

FIG. 4b is an exploded view of the series terminal from FIG. 4a;

FIG. 5 is a lateral view of a series terminal of the type from FIGS. 1, 2a and 2b without a busbar and with a released and relaxed clamping spring in a state in which a conductor could be contacted;

FIG. 6 is the series terminal from FIG. 5 with a clamping spring latched in an open state;

FIG. 7 is a perspective view of a second embodiment of a plurality of series terminals with end and partition plates, which are joinable together to form a terminal block;

FIG. 8 is a lateral view of one of the series terminals from FIG. 7 without a busbar and with a released clamping spring; and

FIG. 9 is an exploded view of the series terminal from FIG. 8 with a busbar.

### DETAILED DESCRIPTION

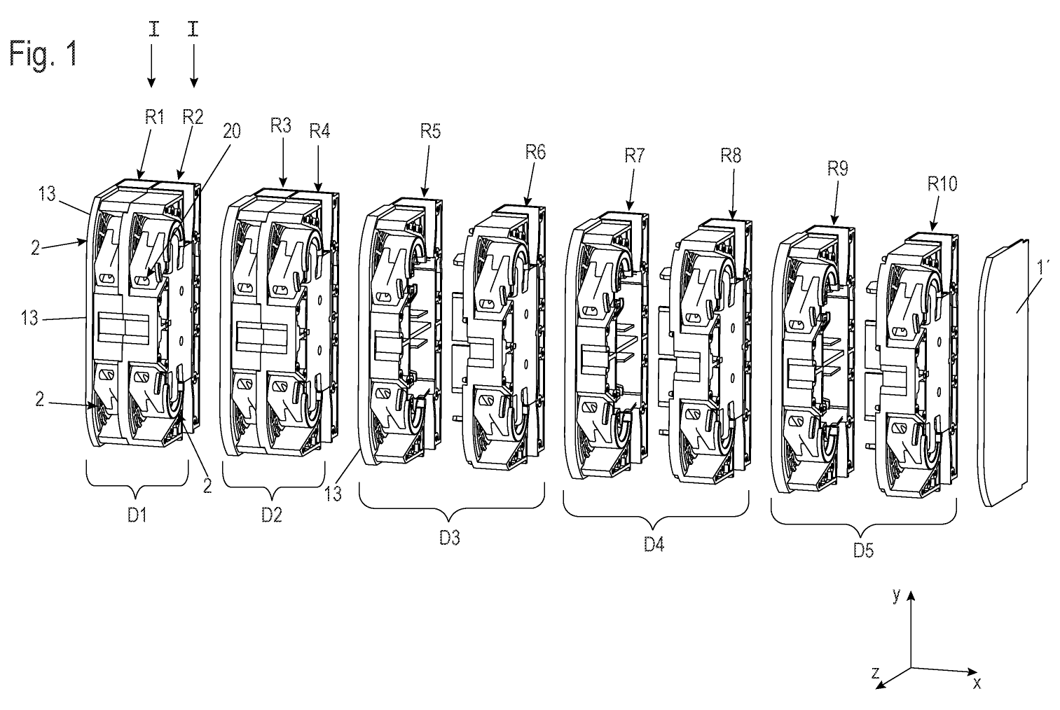

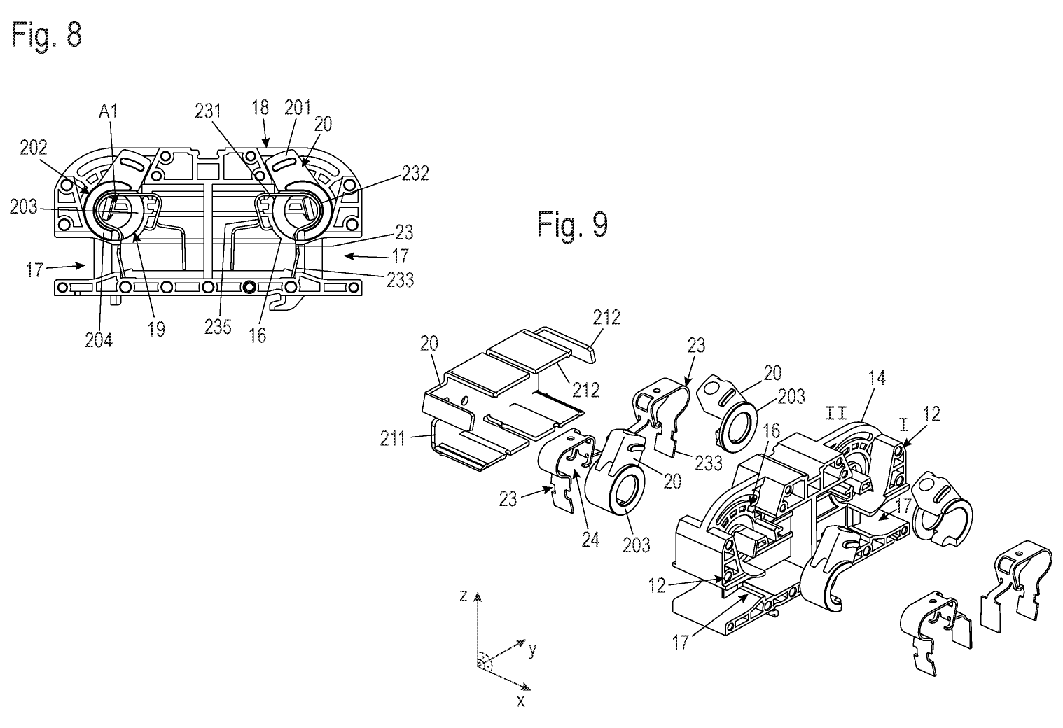

Referring first to FIGS. 1, 2a, 2b, 7 and 8, there are series terminals R1-R10 having a housing 1 and one or more connection devices 2 for conductor ends, which are configured as direct-plug pressure spring connections.

The housings 1 are designed to be essentially plate-shaped and are made of an insulating plastic material. They can be series-mounted in a series-mounting direction X.

In the series-mounting direction X, the connection devices are situated one behind the other in connection planes I or I, II. A number of the connection devices 2 per connection plane I, II can also be provided transverse to the series-mounting direction. Two of the connection devices are preferably provided per connection plane I, II. The connection devices can alternatively also be used individually and individually inserted into a housing 1 (not depicted here). Only one busbar, which is yet to be described, needs to be slightly adapted for this purpose.

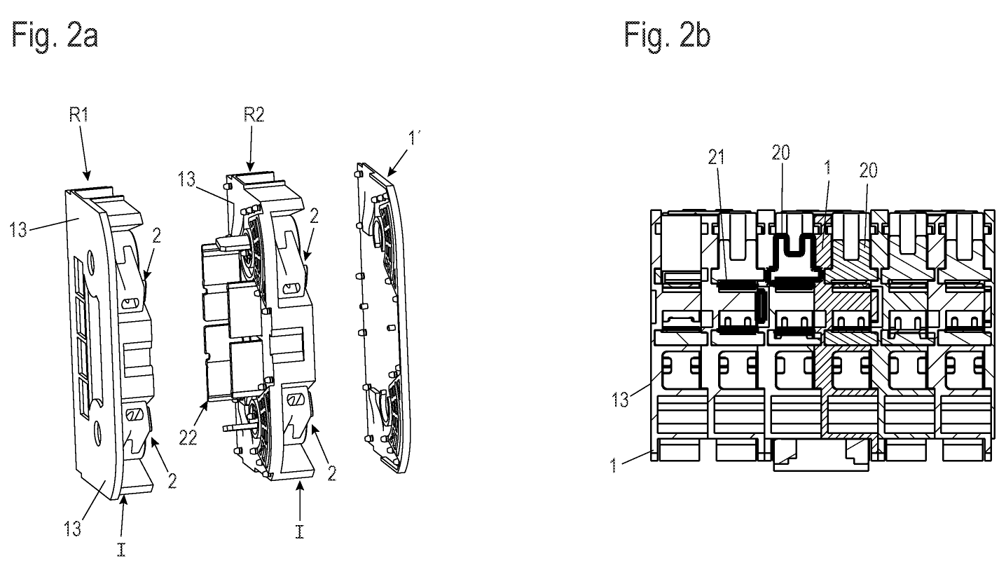

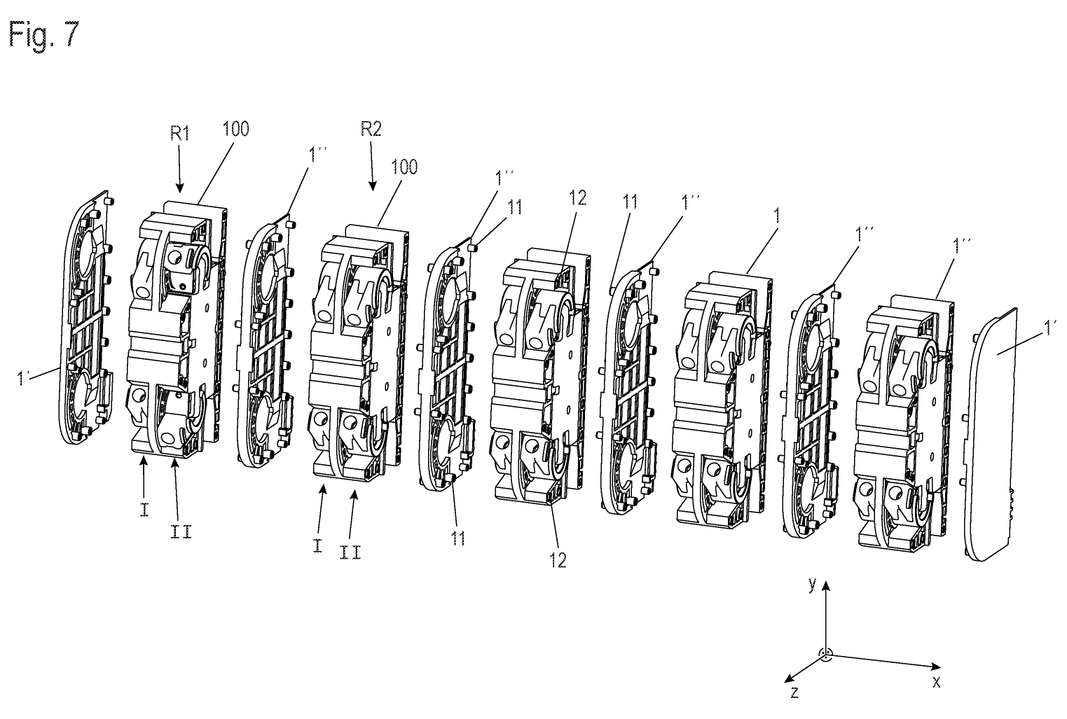

The housings 1, 100 of the series terminals are each designed in a plate-like manner. They can each have a single connection plane I (FIGS. 1 to 6, see, for example, FIG. 2a), two connection planes I, II (FIGS. 7-9) or more than two connection planes (not shown).

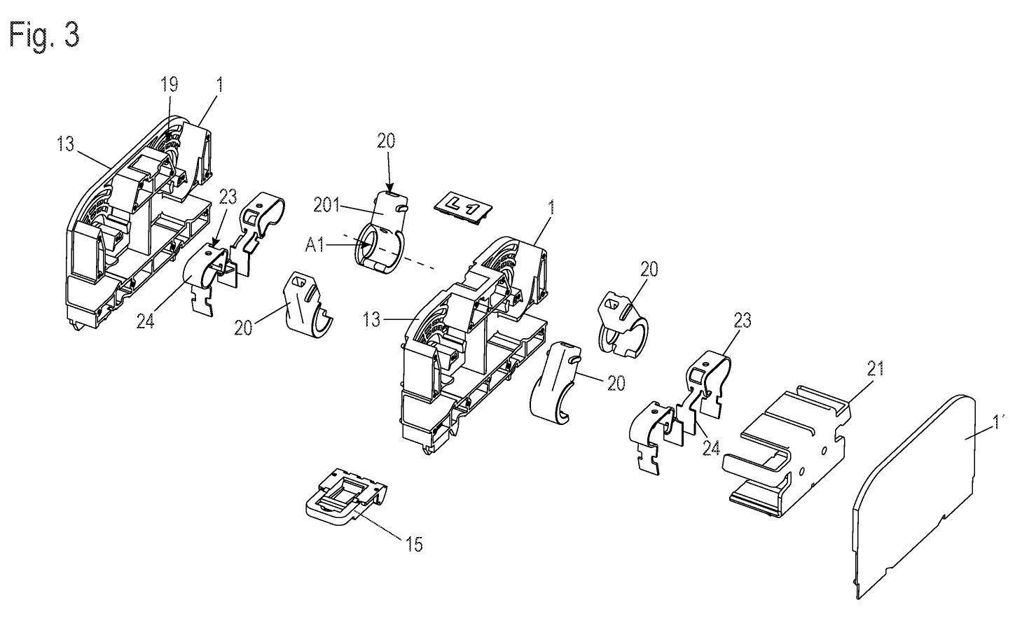

It is preferably envisaged to conductively connect all (in this case four) connection devices 2 from in each case two connection planes I, I or I, II through a single busbar 21 (see in particular FIGS. 2 and 3). If only one connector is provided, or one connector device, this configuration of the busbar 22 is dispensed with.

It can be advantageously envisaged that a separate series terminal R1, R2, is provided for each connection plane 1. Then, two of the series terminals - R1 and R2 as well as R3 and R4, etc. - will be connected with separate housings 1, which are series-mounted next to each other and may be connected in a form-fitting and/or force-fitting manner, in particular in a clamped and/or latched manner, to form a type of double series terminal D1, D2, D3 with only a single busbar 22, which conductively connects the connection devices 2 of both connection planes I, II (see particularly FIGS. 1 and 2a). These double series terminals D1, D2, D3 can then be arranged in the series mounting direction (see particularly FIG. 1). At the end of a respective terminal block, an end wall 1' can optionally be provided, which terminates the respective terminal block laterally.

The busbar 21 connects the connection devices 2 in one connection plane and the connection devices in two connection planes, respectively, which are adjacent to one another in the series-mounting direction X. This is particularly simple and leads to an excellent conductive connection of all connection devices of the respective double series terminals D1, D2, D3.

It can thus be simple and advantageously envisaged that two adjacent series terminals R1-R10 which have two connection planes in the X-direction, each have only a single busbar 21, which is then commonly used by two adjacent series terminals R1, R2. It is also conceivable to use a busbar for more than two adjacent series terminals R1, R2, R3, ..., such as three series terminals, resulting in six of the connection devices 2 being connected together.

The housings 1 can be series-mounted to each other directly in a series-mounting direction X to form a terminal block with several of the double series terminals D1, D2, D3 (FIGS. 1 to 3).

In this case, the respective terminal block can optionally be closed off by an end wall l' that can be placed on an open side of the last housing in the series mounting direction (FIG. 1, FIG. 3). In the configuration according to FIGS. 7-9, the respective terminal block can be closed off on both sides in and against the series mounting direction by such an end wall l' that can be placed on the respective housing 1.

The housings 1 of the series terminals of all exemplary embodiments are each designed in a plate-like manner. They have a single connection plane I (FIGS. 1 to 3), two connection planes I, II (FIGS. 7 to 9) or more than two connection planes (not shown).

In this case, the housings have a base wall that can be configured as a rear wall 13 (FIGS. 1 to 3) or as a center wall 14. In the configuration as a center wall 14, on each of the two main sides (X-direction, -X-direction), one or more of the connection devices 2 for conductors are provided. Between two adjacent housings 1 with a center wall 14, dividing walls 1" can be provided. These dividing walls 1" can also have functional contours such as detent and/or clamping mechanisms for latching to the adjacent housing, and can also be used for bearing the actuating element and possibly for supporting the busbar 20 (FIG. 7).

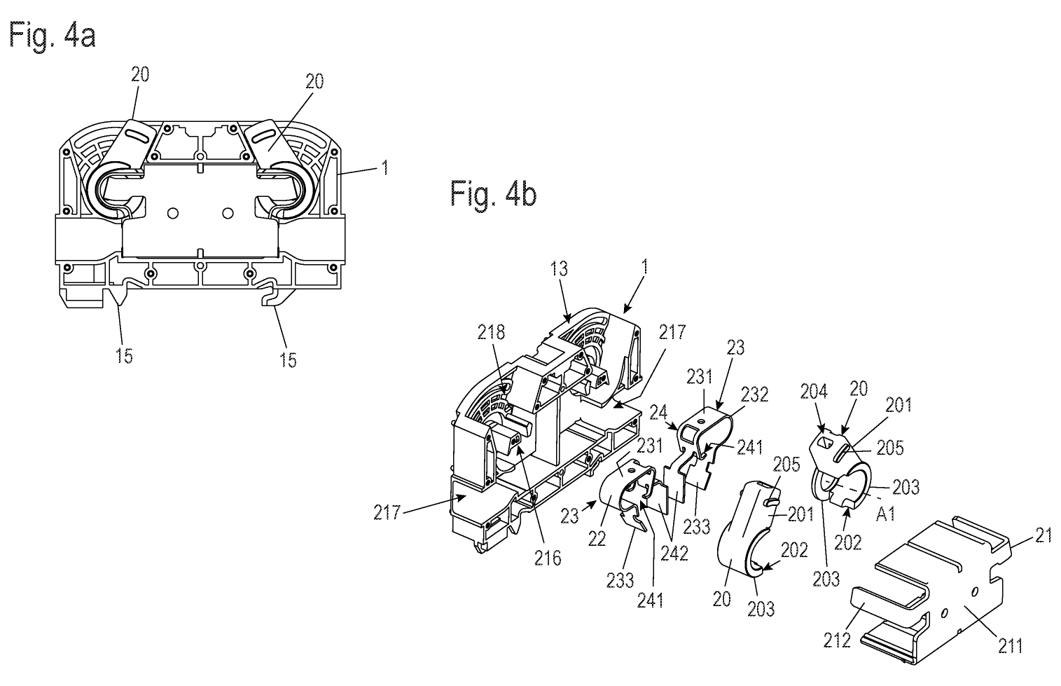

In practice, it is envisaged that a series of housings 1 and, if necessary, the dividing walls l' be placed onto a mounting base such as a mounting rail. Therefore, in such a series (see FIGS. 4a and 4b), one or more of the series-mounted housings 1 can further have a mounting foot 15 (see FIG. 4a). With this, they can be placed, particularly latched, onto the mounting rail (not depicted here). The respective mounting foot 15 can be configured as a type of releasable latching foot. It can also be that only some of the series terminals of a terminal block including a plurality of series terminals (see FIGS. 3, 4, 5) have such a mounting foot 15 provided. The number of respective mounting feet 15 on a terminal block including a plurality of the series terminals is dependent on the number of series-mounted series terminals. The more series terminals which are lined up, the more mounting feet 15 can be provided.

Starting from the mounting base such as the mounting rail, the housings 1 extend upward in the Z-direction as well as transverse thereto in the Y-direction and in the series- mounting direction X.

In this case, the series terminals R1-R10 of all configurations are preferably designed so that they are actuable from the Z-direction and so that the two conductor ends can be introduced into the connection devices 2 from opposite directions +Y and -Y. This is also referred to as 900 actuation (relative to introducing a conductor perpendicular from above in the -Z direction). Typically, this results in introducing a conductor parallel to a control cabinet rear wall.

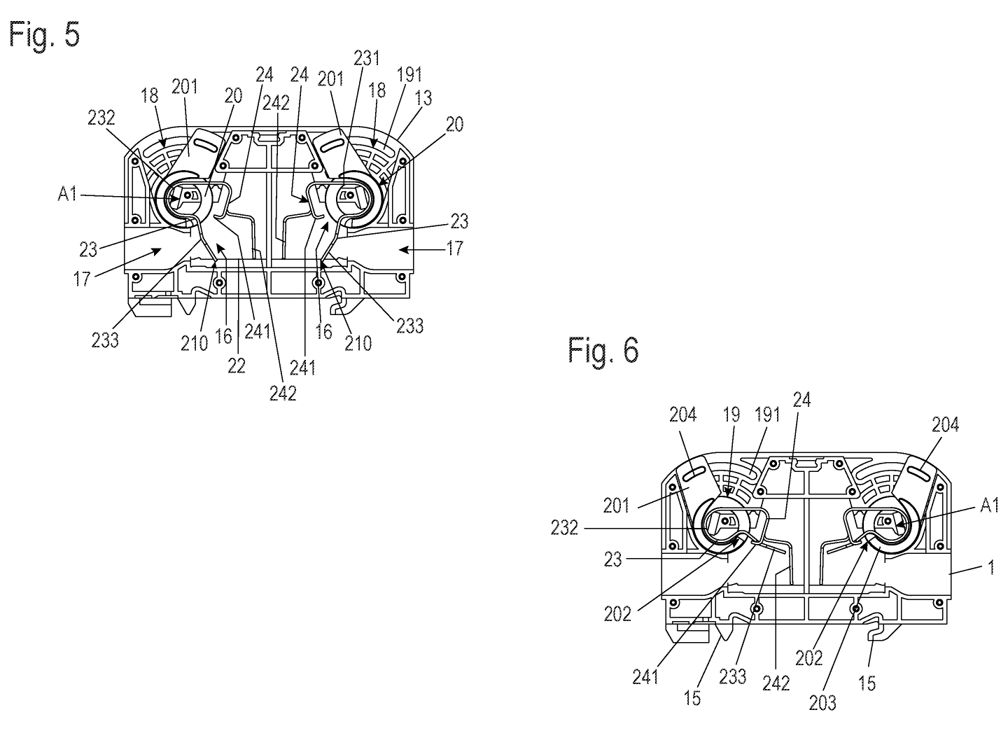

On the rear wall 13 or the center wall 14, various functional areas are configured in or against a series-mounting direction by projections of the housing 1, which define the boundaries of function chambers 16 and/or function channels 17,18 (FIGS. 5 and 9). A support is also defined for a clamping spring 23 to be discussed further, particularly for a curve 232 of the clamping spring.

Preferably, two function chambers 16 and four function channels 17, 18 are provided for each connection plane I, II. The two function chambers 16 of each connection plane I, II essentially serve to accommodate one of the two connection devices 2 for conductor ends. The two function channels 17 serve to feed the conductor ends to the connection devices 2, and the two function channels 18 serve to accommodate the respective actuation sections 201 of respective actuating devices 20 of the connection devices 2.

For each connection plane I or I and II, multiple, preferably two, electrically conductively connected connection devices 2 designed as direct-plug pressure spring terminals are inserted into the housings 1.

For this purpose, the housings 1 on the rear wall 13 towards one side or on the center wall 14 (which is possibly provided instead of the rear wall 13) towards both sides (i.e. in the X-direction and -X-direction; see FIG. 3 and FIG. 2a and 2b) have two of the function chambers 16 and two of the respective function channels 17 and 18 each.

Each connection device 2 is envisaged here to have one of the function channels 17 as a conductor introduction opening in the housing 1, through which the respective conductor end 3 can be introduced into the respective connection device 2. The connection devices 2 are envisaged and configured for connecting a respective conductor end (not shown) in direct-plug pressure spring technology. For this purpose, the conductor ends are introduced into the housing 1 in a Y or -Y direction.

The two function channels 18 for receiving the respective actuating elements 20 are open in the Z direction, so that it is possible to actuate the actuating elements 20 from this direction, for example with a screwdriver.

The connection devices each have a spring configured as a clamping spring 23. Each clamping spring 23 is further assigned an actuating element 20 for actuating the clamping spring 23, with which the clamping spring can be transferred from one operating state to another operating state.

The actuating elements 20 of the connection devices 2 are each inserted with an actuating section 201 into the function channels 18 and function chambers, and held in these.

The clamping springs 23 of the connection devices 2 are each inserted into the function chambers and held in these.

The clamping springs 23 serve to press a conductor end against a contact region 210 of a busbar 21 to establish and maintain an electrical contact between the conductor end and the busbar 21 in the region of a contact zone 210 of the busbar 21 (see FIGS. 5, 6, and 9).

The clamping springs 23 have a supporting limb 231 and a clamping limb 233 connected via the curve 232. They can further have a retaining and detent spring 24 which is designed such that it can be used to lock the clamping limb 233 in an open position at detent bars 241 of the retaining and detent spring 24, in which a conductor end can be introduced into a space between the clamping limb 233 and the contact zone 210 of the busbar 21. The retaining and detent spring 24 can be configured such that when the conductor end is introduced sufficiently far, it hits a releasing limb 242, causing the retaining and detent spring 24 and the clamping spring 23 to be moved relative to each other in such a way that the detent position is released, such that the clamping limb 233 can press the conductor end against the busbar 21 in order to contact it (FIGS. 4, 5, 6 and 9).

The actuating element 20 is used here to move the clamping spring 23 or its clamping limb 233 away from the contact region or a conductor that is contacted there, so that the clamping limb 233 is tensioned and the clamping point is opened, such that any potentially existing electrical contact is released and the potentially contacted conductor end can be removed from the connection device 2.

By further pressing down the clamping limb 233 with the actuating element 20, it can be moved so far that the latching engagement between the retaining and detent spring 24 and the clamping spring 23 is re-established or is created for the first time during manufacturing. (compare FIGS. 5 and 6). The clamping spring 23 is then locked in the open position, and a conductor end can again be introduced into the clamping and contact region.

The connection devices 2 further include an abutment in and at which the clamping springs 23 are supported. This can be provided in the region of the curve 232 or at the supporting limb 231. The design is preferably such that the clamping spring is supported at a metal region of the busbar 21.

The pivotable actuating elements 20 are essentially designed like a one-armed lever, i.e. based on the principle of operation. The actuation area 201 of the pivotable actuating elements 20 (FIG. 3) can be configured as a lever arm.

This lever arm is rotatably borne in an inner end region around a fixed axis Al (FIG. 5, FIG. 6) in the housing 1. The actual pivot bearing itself does not need to be precisely centered in the region of the axis of rotation A1. It is rather realized here by configuring a type of annular path 19 (a kind of circular control curve or an annular groove or the like) in the housing 1 and the series-mounted housing (FIGS. 1 to 6) or a series-mounted dividing wall (FIGS. 7-9), concentrically to the axis of rotation A1, on at least one side of the lever arm or on both sides of the lever arm 201. An axial edge of a cylindrical or semi-circular annular projection engages in each case in the respective annular path 19 in an annular path of movement. This annular projection 203 - which can also be referred to as a cylindrical projection - surrounds the curve 232 of the clamping spring 23.

It has a circumferentially nonclosed contour at least on one side of the lever arm 201 (see FIG. 4b). Thus, in the annular projection, there is a type of recess 203 on which there is configured, in the circumferential direction, a type of leading contour 202, which can be applied against the clamping limb 233 in order to move it away from the contact zone 210 (FIG. 6).

In order to contact a conductor end, it is introduced into the function channel 217, which is a conductor introduction channel. If the conductor end ultimately presses on the releasing limb 242, the retaining and detent spring 24 is released from its locking, allowing the clamping limb 233 of the clamping spring 23 to press the conductor end against the busbar 21 in the region of the contact zone 210 (FIGS. 5 and 6).

Additionally, in the actuating section 201 of the actuating element 21, one or more projections 205 can be provided in the series-mounting direction X and/or against the series- mounting direction, which can engage corresponding ring-segment-like guiding contours in the housing 1, which further improves the pivot bearing of the actuating element 21 (FIG. 4b).

It is particularly advantageous that the actuating devices 20 are configured like a one- armed lever which have an actuating section 201 and the leading contour 202 acting on the clamping limb when the clamping spring is tensioned, wherein the spacing between a free actuating end of the actuating section 201 ("at the top" in FIG. 4b ) and the fixed axis of rotation Al is greater than the spacing between the axis of rotation A1 and the leading contour 202. This is evident in FIG. 4b.

When the actuating element 20 is rotated or pivoted at its free end in one of the two directions of rotation, the leading contour 202 acts on the clamping spring or its clamping limb 233, in order to move it from an open state (FIG. 5) or a clamping state (when a conductor end is contacted, not shown) back to a detent state R (FIG. 6).

In this way, a direct plug-in terminal connection with retaining and detent springs for locking the clamping spring 23 in the open state to introduce a conductor end into the clamping and contact region, can also be excellently integrated as a 90° conductor feed variant with conductor introduction lateral and parallel to a control cabinet rear wall into a series terminal R1, R2, etc.

The clamping spring 23 can be configured as a single-piece metal part with the retaining and detent spring 26, which can be produced easily and referred to as a snap-in spring.

The respective multiple connection devices 2 for connecting a respective conductor end, especially a stranded wire end, have in each case at least the following: a contact zone 210 of the busbar 21 for contacting the respective electrical conductor end 3; the respective clamping spring 23 configured as a pressure spring, with which an electrical conductor end introduced into the connection devices 2 can be pressed against the contact zone 210 to contact the conductor end; the retaining and detent spring 24; and the rotatable actuating element 20 in the form of a lever pivotally mounted at one end, with which the clamping spring 23 can be actuated.

It can be envisaged that the dividing walls 1" and/or the end walls l' or the base walls also have a ring-like guiding track. Then the actuating elements 20 can be supported in a manner pivotable in two directions on the housing 1 and one of these walls, which optimizes the guiding of the actuating element 20. The respective annular-track-like guiding track does not need to be closed in the circumferential direction. It is sufficient if the pivotability of the actuating element 20 is realized in such a way that it is possible to re-tension the clamping spring 23 and to lock it in the open position.

The actuating elements 20 can be completely arranged within the housing 1 or a conceptual envelope contour of the housing 1. They can have an actuating contour 204 to apply a tool such as a screwdriver to pivot them (FIG. 4b).

In the actuating elements 20, at least one test access can optionally be provided. In this way the actuating contours 204 can form these test accesses if they are configured as through holes.

Preferably, the pivot position of the actuating elements 20 in the housings 1 is visible from the outside, namely in the function channels 19. This results in an advantageous status display through the visually recognizable position of the pivotable actuating element 20.

The axis of rotation A1 is parallel to the series mounting direction X. The rotation direction of the actuating element occurs in the circumferential direction around this axis of rotation A1.

The actuation direction (perpendicular from above and then pivoting in the circumferential direction around axis A1) and the conductor introduction direction can preferably be substantially at right angles to each other, with them being able to deviate about 90° ± 25° when actuating. An actuation from above in the Z-direction and a conductor entry perpendicular thereto in the Y-direction are particularly simple, as this is easiest for the operator to accomplish. Moreover, the conductors are also in or parallel to the plane of the control cabinet rear wall, such that bending the conductors in the Z-direction is not necessary.

This results in advantageously ergonomic actuation with little physical effort. In addition, there also arises a compact structural shape with a small number of parts with simple geometry, i.e. the components can be produced and mounted inexpensively.

The two connection devices 2 of each connection plane I, II are preferably arranged in the Y-direction one behind the other. In the series-mounting direction, the two connection devices 2 of the number of connection planes R1, R2 and the potential number of additional series terminals align with each other. They lie on a straight line connecting them.

It is particularly advantageous if the clamp cages 21 of the number of connection devices 2 of the respective series terminal and a connecting busbar 21 for the connection devices 2 are produced as a single piece from sheet metal that is cut using stamping/bending technology, so that they are electrically conductively connected in a simple manner, as is particularly well illustrated in FIGS. 2a and 2b. The busbar 21 can also be composed of several individual sections; however, the single-piece configuration is particularly easy to manufacture. Thus, the busbar 21 is preferably designed as a stamped/bent part made of metal.

It is also envisaged that all the connection devices of a respective connection plane I or II are electrically conductively connected to one another using this one busbar 21.

The busbar 21 can further be configured in such a way that it does not only electrically conductively connects the two connection devices 2 of a respective connection plane I of a series terminal with only a connection plane I or connection planes I, II. Rather, it connects the connection devices 2 of two connection planes I, II of a series terminal with two connection planes I, II, or the connection devices of two adjacent series terminals, each with only a single connection plane I (if the series terminals each have only a single connection plane). In addition, the busbar 21 can also configure or have the contact regions 210, in which conductor ends to be introduced are contacted, and it can also serve as a support or abutment for the clamping springs 23 of the connection devices 2 (FIGS. 1 and 7).

The respective busbars 21 can have a baseplate region 211 which can extend substantially in the Y and Z directions, wherein a number of bars 212 extend approximately at a 90° angle from this baseplate region 211. The bars 212 can configure the contact regions 210 of the number of connection devices 2 from one or two connection planes (I, I; I, II) and/or the abutment bars for metal support of the clamping springs 23.

The bars 212 preferably run through corresponding slots in the housings 1, or are guided past these at the edge, and are preferably so long in the series-mounting direction X that they extend beyond two connection planes I, II or beyond two series terminals with one connection plane each. In this manner they also conductively connect the connection devices 2 of the different connection planes or different series terminals to one another. The bars 212 can also be configured to extend over further series-mounted single or double series terminals.

This leads to a dimensionally stable structure and to an electric current, depending on the realized cross-section, being able to flow across two or more connection planes largely with minimal loss without impairments, as otherwise can occur at connection points between joined- together conductive elements and components.

Preferably, the busbar 21 is made in one piece from a sheet of a highly conductive copper alloy in a stamping/bending process.

Alternatively, it is also conceivable that the busbar 21 itself consists of several individual parts that are electrically conductively connected with each other via a thermal or mechanical joining technique. This is sensible when it is desired to employ busbars constructed as compactly as possible.

Alternatively, casting or 3D metal printing is also conceivable as manufacturing processes for the busbar 21, which have the advantage of enabling particularly complex structures.

The rear sides 13 of the housings 1 can be configured to be fully or substantially closed. In the series mounting direction, a last series terminal can obtain and have an end wall l' serving as a cover plate on the housing (FIGS. 1 and 7).

The connection devices 2 can be designed for various cross-sections, ranging from 2.5 mm² to 25 mm². Preferably, a number of two or more connection devices 2 are provided for each series terminal. Thus, the current can be distributed to various consumers from the connection devices 2 depending on demand.

The series terminals can be assembled in the series mounting direction X into a terminal block composed of several series terminals, which are preferably identically constructed (but possibly differently colored).

Then this terminal block can be used to apply several potentials to it on the input side; e.g. to five double series terminals in each case of one of five potentials. Each of these potentials is then distributed in the respective series terminal to the respective connection devices 2, so that it can be accessed a single or multiple times depending on the number of connection devices 2.

The respective connection device(s) 2 can also be provided in a plug-in connector or in another electrical device. Then, only the busbar 21 is adjusted accordingly. It does not necessarily have to connect several of the connection devices 2 with each other.

What is claimed is:

1. A terminal block comprising a plurality of series-mountable series terminals having one of a clamping and latching connection, each including a housing and two or more connection devices inserted into the respective housing and designed as direct-plug pressure spring terminals for connecting a respective conductor end, the connection devices each including a busbar having a contact zone for contacting the respective electrical conductor end, a clamping spring configured as a pressure spring to press a conductor end introduced into the connection device against the contact zone to contact the conductor, an actuating device pivotable in the housing about an axis of rotation to move a clamping limb of the clamping springs out of a relaxed position and into a tensioned detent position at a retaining and detent spring, wherein each actuating device has a one-armed lever configuration and includes an actuating section and a leading contour to act on the clamping limb when the clamping spring is tensioned.

2. The terminal block according to claim 1, wherein a space between an actuating end of the actuating section and a fixed axis of rotation is larger than a space between the axis of rotation and the leading contour.

3. The terminal block according to claim 1, wherein the actuating device has a pivot bearing formed by a circumferentially closed or nonclosed annular groove arranged in the housing and at least one respective circumferentially closed or nonclosed annular projection arranged on an actuating section and extending perpendicular thereto, the pivot bearing engaging and being pivotable in the respective annular track around an axis of rotation through a pivoting angle.

4. The terminal block according to claim 3, wherein in each of opposite sides of adjacent housings, a housing and a partition, and a housing and an end plate there is the circumferentially closed or nonclosed annular groove and the circumferentially closed or nonclosed annular projection engaging therein.

5. The terminal block according to claim 3, wherein the annular projection surrounds a curve of the clamping spring and has a recess and leading contour formed in a circumferential direction to be applied against the clamping limb when the actuating element is pivoted to move it away from the contact zone and to lock the clamping spring on the retaining and detent spring.

6. The terminal block according to claim 1, wherein the series terminals are series- mountable on a mounting rail and are configurable to be actuated from a Z-direction perpendicular to the mounting rail to introduce two conductor ends from opposite +Y and -Y directions perpendicular to the Z-direction into the housings and the two connection devices arranged therein.

7. The terminal block according to claim 1, wherein the busbar is configured to support a respective clamping spring.

8. The terminal block according to claim 1, wherein the busbar connects a plurality of commonly conductive connection devices situated on a common connection plane perpendicular to the series-mounting direction.

9. The terminal block according to claim 1, wherein the busbar includes a single common one-part busbar for all connection devices of two or more adjacent connection planes to commonly connect the connection devices in a conductive manner via the single busbar.

10. The terminal block according to claim 1, wherein the clamping spring and the retaining and detent spring are formed in one piece, the clamping spring being lockable with the detent spring in an open position to introduce a conductor end into a contact area of the respective connection device, the retaining and detent spring being releasable from the locked state with the conductor end when the conductor end is introduced to press the conductor end against the respective contact zone.

11. The terminal block according to claim 1, wherein the housings of respectively adjacent series terminals of the terminal block are mechanically connected to one another in one of a force-fitting manner, form-fitting manner, and both force-fitting and form fitting manner in the series-mounting direction by one of clamping, locking, and clamping and locking the respective adjacent housings.

12. The terminal block according to claim 1, wherein in each case two of the housings are joinable together per a connection plane from two or more connection devices into a double series terminal having a common busbar for the connection devices.

13. The terminal block according to claim 1, wherein a housing is arranged on either side of a center wall, each having a connection plane of two or more connection devices to form a double series terminal with two connection planes, a dividing wall connected with each housing to connect two housings in one of a force and form-fitting manner to form a series mount in the series-mounting direction.

14. The terminal block according claim 1, wherein the busbar has a baseplate region extending substantially in the Y and Z directions and a plurality of bars extending approximately at a 90° angle therefrom, wherein the bar configures one of the contact region of the plurality of connection devices from one or more connection planes, abutment bars for metal support of the clamping springs, and both the contact region and abutment bars.

15. The terminal block according to claim 14, wherein the busbar plurality of bars have a length in the series-mounting direction to extend beyond at least two connection planes of a series terminal or two or more series terminals with one connection plane each to conductively connect the respective connection devices.

16. The terminal block according to claim 1, wherein one or more of the series terminal housings of the terminal block is lockable onto a mounting rail via one of a single-piece and multipiece locking foot.

17. A connection device for connecting a conductor end and for connecting the conductor end to a busbar for one of a terminal block, a plug-and-socket connector, and another electrical apparatus, comprising a housing and a direct-plug pressure spring terminal inserted into the housing for connecting a respective conductor end and having at least one busbar having at least one contact zone for contacting the respective electrical conductor end, a clamping spring being configured as a pressure spring to introduce the conductor end into a connection device to be pressed against the contact zone to contact the conductor, an actuating device being pivotable in the housing about an axis of rotation to move a clamping limb of the clamping spring out of a relaxed position into a tensioned detent position at a retaining and detent spring, wherein the actuating device has a one-armed lever configuration having an actuating section and a leading contour which acts on a clamping limb when the clamping spring is tensioned.

18. The connection device according to claim 17, wherein a space between an actuating end of an actuating section and a fixed axis of rotation is larger than a space between the axis of rotation and the leading contour.
